(19) United States
(12) Patent Application Publication
(10) Pub. No.: US 2005/0252512 A1
(43) Pub. Date: Nov. 17, 2005

(54) Apparatus for hypoxic training and therapy

(76) Inventor: David Paul Sumners, Middlesbrough (GB)

Correspondence Address: ANTHONY R. BARKUME, 20 GATEWAY LANE, MANORVILLE, NY, 11949, US

(21) Appl. No.: 10/507,141

(22) PCT Filed: Mar. 12, 2003
(86) PCT No.: PCT/GB03/01041

§ 371 Date: May 20, 2005

(30) Foreign Application Priority Data
Mar. 12, 2002 (GB) 0205759.4

(51) Int. Cl. A62B 7/10

(52) U.S. Cl. 128/205.28

(57) ABSTRACT

Breathing equipment to mimic the training of athletes at high altitude comprises a mouthpiece (1) connected to a chamber (3) containing a carbon dioxide absorber which is connected to the atmosphere by a (tube 4). In use the air breathed out passes through the carbon dioxide absorber into the conduit where it mixes with atmospheric air and the mixture is re-breathed.

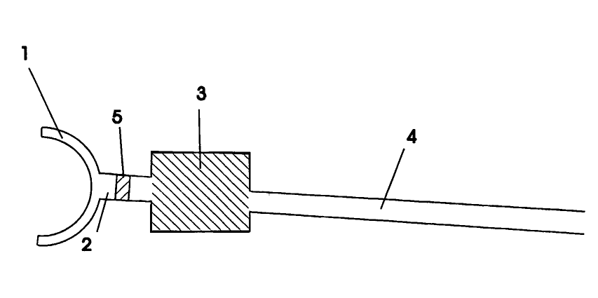

This invention relates to equipment for improving the breathing of people such as athletes, singers, people with breathing difficulties and anyone who wants to improve the efficiency of their breathing and endurance.

Athletes, particularly those who take part in middle and long distance events, often train at high altitudes as such high altitude training is known to improve their performance. This improvement is thought to be due to the lower oxygen levels at high altitudes resulting in the body having to become more efficient in its operations.

An acclimated athlete can run at high altitudes because the body can adapt to hypocapnia. This adaptation permits greatly increased ventilation which supplies enough O₂ not only to prevent hypoxia at rest but also provides enough ventilation for strenuous running. This adaptation brings about improved performance at lower altitudes.

However, this adaptive process does not always go smoothly, and acute mountain sickness is a common occurrence. At high altitudes, the alternating stimulation and inhibition of the respiratory centre, first by hypoxia and then by hypocapnia, leads to Cheyne-Stokes respiration, which can become quite pronounced during sleep. In the apneic phase, severe hypoxia may potentially cause the subject to slip from sleep into coma, and sometimes from coma into death.

A voluntary increase in the rate and depth of breathing causes CO₂ to be exhaled at a faster rate than its rate of production by the body's metabolism and results in a drop in the amount of CO₂ in the blood, i.e., results in hypocapnia. If vigorous, rapid breathing is continued for more than a few minutes, increasingly severe hypocapnia will cause cerebral vasoconstriction and unpleasant nervous system symptoms.

An increased rate and depth of breathing, or hyperpnoea, without an appropriate increase in CO₂ production from metabolism, can be voluntary or caused by a hyperventilation syndrome, anoxic hypoxia, or mechanical ventilation. In all cases, the resultant hypocapnia causes increasingly grave symptoms and is the limiting factor in the amount of excess ventilation that can be achieved. In a number of situations—a good example is the anoxic hypoxia that can occur in high altitude flying—a large increase in ventilation is desirable, and CO₂ enriched air makes this possible.

Various attempts to utilize exhaled air, which is high in CO₂, have been made as a substitute for providing prepared custom mixes of CO₂ and air. In fact, generations of emergency room physicians have had patients breathe into simple Kraft paper bags to treat hyperventilation that can result from anxiety, fear, or trauma. The paper bag enables a hyperventilating patient to conserve and rebreathe exhaled air.

Variations on the use of paper bags are described in U.S. Pat. Nos. 3,455,294; 4,508,116 and 4,628,926. Long tubes have been substituted for paper bags and these tubes essentially mimic the effect of paper bags.

U.S. Pat. No. 4,275,722 discloses a respiratory exerciser and rebreathing device which, through a system of valves, provides for an inhalation chamber and an exhalation chamber, with a sliding mechanism to vary the amount of air rebreathed from the exhalation chamber. This device has a complex network of chambers, valves and mechanisms, all designed to route exhaled air through an exhalation chamber and through an inhalation chamber that removes moisture from the exhaled air before inhaling. The exhalation chamber is widely open to ambient air so that fresh air is available at the bottom.

These devices all are designed to combat the effects of breathing problems at high altitude and to overcome physiological difficulties and cannot be used to reproduce the effect of high altitude training.

Efforts to reproduce the effect of high altitude training at lower altitudes, in order to avoid the expense of travel to, and living in places of high altitudes by training in rooms or chambers with reduced air pressure are expensive to set up and operate and inconvenient to use. Restricting the airflow to an athlete whilst he or she is training is not effective as the volume of air taken with each breath is reduced, which can cause adverse effects on the athlete. Existing equipment which involves the use of re-breathing air so that the air has a lower oxygen content is not practical as this can lead to excessive carbon dioxide build up as detailed above.

We have now devised a simple effective device for at least partially reproducing the effect of high altitude training which dies not suffer from these disadvantages.

According to the invention there is provided breathing equipment which comprises a mouthpiece through which a user can breath, which mouthpiece is connected to the inlet of a chamber containing a carbon dioxide absorber, the outlet of the chamber being connected to a conduit which is open to the atmosphere in which, in use, the air in said conduit comprises a mixture of air which has been breathed out by the user and air from the atmosphere, which mixture is breathed in by the user.

The carbon dioxide absorber can be any of the conventionally used carbon dioxide absorbers such as caustic soda pellets, soda lime etc. Preferably the carbon dioxide absorber changes colour as it absorbs carbon dioxide and so it can be seen when it is used up.

The conduit can be a flexible tube and the length of the conduit depends on the amount of air from the atmosphere it is desired to add to the air to be re-breathed, with the longer the conduit the less fresh air form the atmosphere is added on each breath. For tubes of diameter 1.5 cm to 4 cm tubes of lengths of 50 cm to 1.5 metres can be used.

The air from the atmosphere enters the conduit by diffusion and by the reduction in pressure caused by each in-breath.

In use, the mouthpiece is attached to the user's face e.g. by being tied on means of straps or an elasticated bands etc. As there is a reduction in oxygen input in use there is preferably an automatic release mechanism so that, in the event of discomfort, air can enter directly into mouthpiece.

In use the air is breathed out by the user and passes through the carbon dioxide absorber chamber where excess carbon dioxide is absorbed, and then into the conduit, where it mixes with air from the atmosphere. This air is breathed in through the carbon dioxide absorber chamber and the air breathed will consist of air with an oxygen and carbon dioxide content similar to that found at high altitude. By adjustment of the length of the conduit and the carbon dioxide absorber chamber contents, the conditions at a selected altitude can be reproduced. This enables a graduated acclimatisation to high altitude conditions to be achieved and is equivalent to high altitude training.

As well as being used for training athletes, the equipment of the present invention can be used for helping people with weak or defective breathing strengthen their breathing and improve the efficiency of their oxygen metabolism and can be used for overcoming the effects of accidents and disability which result in weakened breathing.

The invention is illustrated in the accompanying drawing in which there is a mouthpiece (1) connected by tube (2) to a chamber (3) containing soda lime. At the exit of chamber (3) is a flexible tube (4).

In use, a user straps the mouthpiece over his face so that the user breathes in and out through the mouthpiece (1). When a user breathes out the air breathed out by the user passes through the carbon dioxide absorber chamber (3), where excess carbon dioxide is absorbed, and then into the tube (4), where it mixes with air from the atmosphere. This air is then breathed in through the carbon dioxide absorber chamber (3) and the air breathed in will consist of air with an oxygen and carbon dioxide content similar to that found at high altitude. By adjustment of the length of the conduit (4) and the carbon dioxide absorber chamber (3) contents, the conditions at a selected altitude can be reproduced. This enables a graduated acclimatisation to high altitude conditions to be achieved and is equivalent to high altitude training.

There is release valve (5) which can be actuated to open an air inlet directly into the mouthpiece in case of discomfort or danger; such a valve can be actuated automatically under specified conditions.

1-6. (canceled)

7. Breathing equipment which comprises (i) a mouthpiece through which a user can breath in and out, (ii) a chamber containing a carbon dioxide absorber; the inlet of the chamber being connected to the mouthpiece and the outlet of the chamber being connected to a conduit which is open to the atmosphere and in which, in use, the air in said conduit comprises a mixture of air which has been breathed out by the user and air from the atmosphere, which mixture is breathed in by the user through the chamber.

8. Breathing equipment according to claim 7 in which the carbon dioxide absorber comprises caustic soda pellets or soda lime modified so that the absorber changes colour as it absorbs carbon dioxide.

9. Breathing equipment according to claim 7 in which there are attachment means to attach the mouthpiece to the face of a user.

10. Breathing equipment according to claim 9 in which the attachment means are straps, an elasticated band or the like.

11. Breathing equipment according to claim 7 in which the conduit comprises a tube of diameter of 1.5 cm to 4 cm and a length of 50 cm to 1.5 metres.

12. Breathing equipment according to claim 7 in which there is a release mechanism which, when actuated, enables air to enter directly into mouthpiece without passing through the carbon dioxide absorber.

13. Breathing equipment according to claim 11 in which there is a release mechanism which, when actuated, enables air to enter directly into mouthpiece without passing through the carbon dioxide absorber.

14. A breathing equipment for progressive breath training which comprises (i) a mouthpiece through which a user can breath in and out, (ii) a chamber containing a carbon dioxide absorber; the inlet of the chamber being connected to the mouthpiece and the outlet of the chamber being connected to a conduit which is open to the atmosphere and in which, in use, the air in said conduit comprises a mixture of air which has been breathed out by the user and air from the atmosphere, which mixture is breathed in by the user through the chamber and in which, by increasing the length of the conduit, the proportion of oxygen in the air breathed in is decreased.

15. Breathing equipment according to claim 13 in which the tube has a diameter of 1.5 cm to 4 cm and a length of 50 cm to 1.5 metres.

16. A method for breath training in which air breathed out by the user passes through a carbon dioxide absorber in a chamber where excess carbon dioxide is absorbed, and then into a conduit open to the atmosphere, in which conduit the air breathed out is mixed with air from the atmosphere, this air mixture is then breathed in through the carbon dioxide absorber and, by varying the length of the conduit, the oxygen content of the air breathed in is varied.

17. A method as claimed in claim 16 in which the length of the conduit and the content of the carbon dioxide absorber in the chamber are adjusted so that the air breathed in consists of air with an oxygen and carbon dioxide content similar to that found at a high altitude.

18. A method according to claim 16 in which the conduit comprises a tube of diameter of 1.5 cm to 4 cm and a length of 50 cm to 1.5 metres.

19. A method according to claim 17 in which the conduit comprises a tube of diameter of 1.5 cm to 4 cm and a length of 50 cm to 1.5 metres.
